(19) United States
(12) Patent Application Publication
(10) Pub. No.: US 2024/0261719 A1
(43) Pub. Date: Aug. 8, 2024

(54) SYSTEMS AND METHODS FOR DEHUMIDIFYING AND PURIFYING AIR THROUGH COAL-BASED ELECTROTHERMAL SWING ADSORPTION

(71) Applicant: CARBON HOLDINGS INTELLECTUAL PROPERTIES, LLC, Sheridan, WY (US)

(72) Inventors: Charles S. Hill, Sheridan, WY (US); James T. Dietz, Mars, PA (US)

(21) Appl. No.: 18/432,975

(22) Filed: Feb. 5, 2024

Related U.S. Application Data
(60) Provisional application No. 63/483,223, filed on Feb. 3, 2023.

(51) Int. Cl. B01D 53/04; B01D 53/26

(52) U.S. Cl. CPC B01D 53/0462; B01D 53/261; B01D 2253/102; B01D 2253/342; B01D 2257/80; B01D 2259/40043; B01D 2259/4508

(57) ABSTRACT

An electrothermal swing adsorption system includes an electrothermal swing adsorption apparatus. The electrothermal swing adsorption apparatus includes a first chamber comprising at least one carbon monolith and a second chamber comprising at least one carbon monolith. The electrothermal swing adsorption apparatus receives a feed of air, desorbs at least one of moisture and air contaminants from the feed of air, discharges a dehumidified flow stream, and discharges a removal output flow stream of at least one of moisture and air contaminants.

### CROSS-REFERENCE TO RELATED APPLICATION

This patent application is a nonprovisional patent application of and claims priority to U.S. Provisional Application No. 63/483,223 filed Feb. 3, 2023, and titled “Systems and Methods for Dehumidifying and Purifying Air Through Coal-Based Electrothermal Swing Adsorption,” the disclosure of which is hereby incorporated herein by reference in its entirety.

### FIELD

The described embodiments relate generally to dehumidification through a coal-based electrothermal swing adsorption system that dehumidifies air and reduces air contaminants. More particularly, the present embodiments relate systems, apparatuses, and methods for dehumidifying and purifying air from a building's heating, ventilation, and air conditioning (HVAC) system.

### BACKGROUND

Many buildings include heating, ventilation, and air conditioning (HVAC) systems. Many of these HVAC systems include dehumidification systems to remove moisture from the air in the HVAC system and include air purification systems to remove air contaminants from the air in the HVAC system. Liquid desiccant air conditioning (LDAC) systems are beginning to be implemented in commercial and residential applications. However, each of these systems suffer from inefficiencies and repeated maintenance issues that add to their cost and effectiveness.

### SUMMARY

In at least one example, an electrothermal swing adsorption system includes an electrothermal swing adsorption apparatus. The electrothermal swing adsorption apparatus includes a first chamber including at least one carbon monolith and a second chamber including at least one carbon monolith. The electrothermal swing adsorption apparatus receives a feed of air, desorbs at least one of moisture and air contaminants from the feed of air, discharges a dehumidified flow stream, and discharges a removal output flow stream of at least one of moisture and air contaminants.

In one example, the at least one carbon monolith of the first chamber adsorbs at least one of moisture and air contaminants and the at least one carbon monolith of the second chamber desorbs at least one of moisture and air contaminants simultaneously as the at least one carbon monolith of the first chamber adsorbs at least one of moisture and air contaminants. In one example, the at least one carbon monolith of the second chamber adsorbs at least one of moisture and air contaminants and the least one carbon monolith of the first chamber desorbs at least one of moisture and air contaminants simultaneously as the at least one carbon monolith of the first chamber adsorbs at least one of moisture and air contaminants. In one example, the first chamber and the second chamber operate in a cyclical fashion to perform continuous adsorption and desorption of at least one of moisture and air contaminants such that adsorption occurs in one of the first chamber and the second chamber while desorption occurs in the other of the first chamber and the second chamber. In one example, each carbon monolith includes coal-based activated carbon fiber. In one example, each carbon monolith is optimized to adsorb moisture or a specific air contaminant. In one example, the electrothermal swing adsorption apparatus includes a reservoir to store the moisture desorbed from the at least one carbon monolith of the second chamber. In one example, the electrothermal swing adsorption system further includes a plurality of electrothermal swing adsorption apparatuses that are arranged in series such that each electrothermal swing adsorption apparatus adsorbs at least one or more of moisture and air contaminants from the feed of the air. In one example, each electrothermal swing adsorption apparatus discharges the removal output flow stream for at least one of moisture and air contaminants. In one example, each electrothermal swing adsorption apparatus includes a reservoir to store the output of at least one of moisture and air contaminants. In one example, the electrothermal swing adsorption system achieves moisture removal efficiencies of at least 396 mg/g at a relative humidity of 98% and temperature of 298 K.

In at least one example, a method of dehumidifying and purifying air from a building HVAC system utilizing a electrothermal swing adsorption system includes feeding air from a building HVAC system into a first chamber of an electrothermal swing adsorption apparatus, adsorbing at least one of moisture and air contaminants with a first carbon monolith in the first chamber, and discharging an output flow stream from the first chamber of the electrothermal swing adsorption apparatus of dehumidified and purified air.

In one example, the method further includes feeding a purge gas into a second chamber of the electrothermal swing adsorption apparatus that is separate from the first chamber, and desorbing at least one of moisture and air contaminants from a second carbon monolith with the purge gas in the second chamber, wherein the second carbon monolith previously adsorbed at least one of moisture and air contaminants. In one example, the method further includes discharging a removal stream from the second chamber of the electrothermal swing adsorption apparatus of at least one of moisture and air contaminants. In one example, the method further includes applying an electrical current to the second carbon monolith in the second chamber to raise a temperature of the second carbon monolith to desorb the at least one of moisture and air contaminants from the second carbon monolith. In one example, the method further includes reversing the feed of air from the building HVAC from the first chamber to the second chamber and reversing the feed of the purge gas from the second chamber to the first chamber when the first carbon monolith has adsorbed a predetermined amount of the at least one of moisture and air contaminants. In one example, the method further includes adsorbing the at least one of moisture and air contaminants with the second carbon monolith in the second chamber, and desorbing the at least one of moisture and air contaminants from the first carbon monolith with the purge gas in the first chamber. In one example, the first carbon monolith and the second carbon monolith include coal-based activated carbon fibers. In one example, the coal-based activated carbon fibers are optimized to adsorb moisture or a specific air contaminant. In one example, the electrothermal swing adsorption system includes a plurality of electrothermal swing adsorption apparatuses that are arranged in series, wherein the feed of air of the building HVAC is feed into each electrothermal swing adsorption apparatus in series and each electrothermal swing adsorption apparatus adsorbs moisture or a specific air contaminant.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 illustrates a schematic of an electrothermal swing adsorption system with a plurality of electrothermal swing adsorption apparatuses according to one embodiment of the present disclosure.

FIG. 2 illustrates a schematic of an electrothermal swing adsorption apparatus in a first configuration according to one embodiment of the present disclosure.

FIG. 3 illustrates a schematic of the electrothermal swing adsorption apparatus of FIG. 2 in a second configuration.

FIG. 4 illustrates a flowchart of a method of dehumidifying and purifying air from a building's heating, ventilation, and air conditioning (HVAC) system using a first electrothermal swing adsorption apparatus according to one embodiment of the present disclosure.

### DETAILED DESCRIPTION

The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components, as appropriate. For instance, methods described can be performed in an order different from that described, and various steps can be added, omitted, or combined. Also, features described with respect to some embodiments can be combined in other embodiments.

Dehumidification systems utilizing activated carbon fiber cloth have been demonstrated to be effective and renewable when heated and regenerated by solar energy. The present disclosure is directed to a dehumidification system for a building's heating, ventilation, and air conditioning (HVAC) system utilizing an electrothermal swing adsorption system. While the present disclosure discusses utilizing the electrothermal swing adsorption system with a building's HVAC, the electrothermal swing adsorption system may be utilized in a number of different situations and may be used to dehumidify air in a number of different situations other than HVAC systems. For example, they may be used for solvent recovery in chemical refining or other industrial processes such as composites manufacturing or manufacture of construction materials including oriented strand board (OSB).

Electrothermal desorption may be accomplished in the electrothermal swing adsorption system by passing an electric current through an activated carbon fiber in an activated carbon fiber monolith to induce Joule heating. This has been shown to be highly efficient compared to other heating methods, such as gas burners, external resistance elements, and the like. By utilizing an electrothermal swing adsorption system that includes alternating adsorption and desorption chambers, an all-electric dehumidification system will be able to dehumidify air while reducing carbon dioxide and other air contaminants in the air of the building's HVAC system. In other words, the dehumidification system may also purify the air in the building's HVAC system as it simultaneously dehumidifies the air. In addition, the disclosed dehumidification and purification system has the added benefit of reducing the amount of fresh air that must be exchanged with the building's air to maintain air qualify during indoor air conditioning.

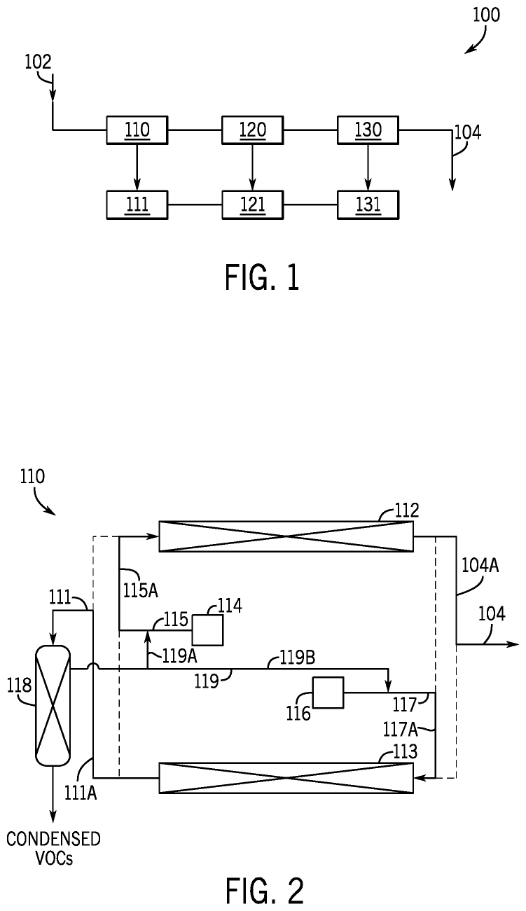

FIG. 1 illustrates an electrothermal swing adsorption system 100 accordingly to one embodiment of the present disclosure. The electrothermal swing adsorption system 100 is configured to dehumidify air and reduce carbon dioxide and other contaminates from air. In other words, moisture is removed from the air. The electrothermal swing adsorption system 100 may be used in a building to dehumidify air in the building's HVAC system. The electrothermal swing adsorption system 100 includes an intake flow stream 102 of air from a building's HVAC system and an output flow stream 104 of dehumidified and/or purified air. The term dehumidified means that the percent of moisture in the air is between 30% and 50% (reduced from 50%-100%), and not a complete removal of moisture from the air. The term purified does not mean a complete removal of all air contaminants, but means that an acceptable level of air contaminants concentration (in ppm) is found in the output flow stream 104. For Example reducing the concentration of a given urban air toxic pollutant or hazardous air pollutant HAP) from >800 ppm to <300 ppm.

The electrothermal swing adsorption system 100 may include a plurality of electrothermal swing adsorption apparatuses 110, 120, 130 that are arranged in series. The illustrated embodiment illustrates a first electrothermal swing adsorption apparatus 110, a second electrothermal swing adsorption apparatus 120, and a third electrothermal swing adsorption apparatus 130. In other words, the air in the intake flow stream 102 is dehumidified and purified by the first electrothermal swing adsorption apparatus 110, then the air is dehumidified and purified by the second electrothermal swing adsorption apparatus 120, and then the air is dehumidified and purified by the third electrothermal swing adsorption apparatus 130. However, the present disclosure is not so limited, and the electrothermal swing adsorption system 100 may include more or less than three electrothermal swing adsorption apparatuses to dehumidify and purify the intake flow stream 102 of air from the building's HVAC system.

In some embodiments, the electrothermal swing adsorption apparatuses 110, 120, 130, of the electrothermal swing adsorption system 100 may be arranged in parallel. In other words, the electrothermal swing adsorption apparatuses 110, 120, 130 may dehumidify and purify the intake flow stream 102 simultaneously to increase the rate in which the air from the intake flow stream 102 is dehumidified and purified.

In addition, each of the electrothermal swing adsorption apparatuses 110, 120, 130 of the electrothermal swing adsorption system 100 includes a removal output flow stream 111, 121, 131 of moisture and other adsorbates that are discharged from the corresponding electrothermal swing adsorption apparatus 110, 120, 130. Each electrothermal swing adsorption apparatus 110, 120, 130 may be optimized for the adsorption of moisture, carbon dioxide, or another air contaminant. For example, the first electrothermal swing adsorption apparatus 110 may be optimized to remove moisture from the intake flow stream 102 to dehumidify the intake flow stream, the second electrothermal swing adsorption apparatus 120 may be optimized to remove carbon dioxide from the intake flow stream 102 after the first electrothermal swing adsorption apparatus 110 removed moisture from the intake flow stream 102, and the third electrothermal swing adsorption apparatus 130 may be optimized to remove carbon monoxide from the intake flow stream 102 after the first electrothermal swing adsorption apparatus 110 and the second electrothermal swing adsorption apparatus 120 removed moisture and carbon dioxide from the air in the intake flow stream 102. The result is that the output flow stream 104 is dehumidified and purified of air contaminants. The electrothermal swing adsorption system 100 may include additional electrothermal swing adsorption apparatuses to remove other specific air contaminants from the intake flow stream 102, including, but in no way limited to, lead, nitrogen oxides, ozone, particulate matter, sulfur dioxide, and the like.

A first removal output flow stream 111 may transfer or output the moisture or other adsorbates to a first reservoir for storing moisture or other adsorbates. A second removal output flow stream 121 may transfer or discharge the moisture or other adsorbates to a second reservoir for storing the moisture or other adsorbates. A third removal output flow stream 131 may transfer or discharge moisture or other adsorbates to a third reservoir for storing the moisture or other adsorbates. In some embodiments, the first, second, and third reservoirs are different reservoirs that either store moisture or a specific adsorbate. In some embodiments, the first, second, and third reservoirs is the same reservoir that stores moisture all of the different adsorbates adsorbed in the electrothermal swing adsorption apparatuses 110, 120, 130.

FIG. 2 illustrates a schematic of the electrothermal swing adsorption apparatus 110 in a first configuration. While FIG. 2 illustrates only a schematic of the electrothermal swing adsorption apparatus 110 in the first configuration, the electrothermal swing adsorption apparatuses 120, 130 in the first configuration are similar to the schematic of the first electrothermal swing adsorption apparatus 110 in the first configuration.

The first electrothermal swing adsorption apparatus 110 includes a first chamber 112 and a second chamber 113. The first chamber 112 and the second chamber 113 each house at least one carbon monolith. In some embodiments, the first chamber 112 and the second chamber 113 each only house a single carbon monolith. In some embodiments, the first chamber 112 and the second chamber 113 may each house multiple carbon monoliths.

In the illustrated embodiment, the first chamber 112 includes an active carbon monolith for adsorbing moisture and/or air contaminants and the second chamber 113 includes a regenerating carbon monolith for desorbing moisture and/or air contaminants from the regenerating carbon monolith. The regenerating carbon monolith in the second chamber 113 had previously adsorbed moisture and/or air contaminants. In some embodiments, the carbon monolith in the second chamber 113 has not yet adsorbed moisture and/or air contaminants when it is first placed in the second chamber 113. The first chamber 112 and the second chamber 113 operate in a cyclical fashion to perform continuous adsorption and desorption of moisture and/or air contaminants.

The carbon monoliths of the first chamber 112 and the second chamber 113 each includes coal-based activated carbon fibers. The coal-based activated carbon fibers are procured from a coal feedstock, which allows them to be 50% to 75% more economical than existing fibers on the market produced from polyacrylonitril (PAN), rayon, and petroleum pitch precursors. The carbon fiber is produced by melt blowing isotropic pitch derived from sub-bituminous carbon ore by the direct coal liquefaction process. The use of sub-bituminous carbon ore as the precursor allows the carbon monoliths to be produced at much lower cost than possible with other types of activated carbon fiber or granular activated carbons. As such, sub-bituminous carbon ore makes the systems economical to produce. These novel carbon fiber monoliths include the elimination of the need for a binder and the elimination of one carbonization step.

The carbon monoliths and the coal-based activated carbon fibers may be optimized for the adsorption of moisture or a specific air contaminant. Functionalizing the activated carbon fibers to specifically target moisture and indoor air contaminants is possible given that this has been evaluated for oxygen containing functional groups and demonstrated for silica nanoparticle doped activated carbon fibers. Properties of the activated carbon fibers may be tailored so improved moisture adsorption and system performance is achieved. Properties of the activated carbon fibers may include pore diameter, pore size distribution, Brunauer-Emmett-Teller (BET) surface area, thermal conductivity, bulk density, air permeability, and electrical resistance. The carbon monolith of the first chamber 112 and the carbon monolith of the second chamber 113 may be similar so each carbon monolith targets moisture or the same specific air contaminant.

For example, the bulk density of the carbon monoliths can be greater than about 0.05 g/cm³. In some examples, the bulk density of the carbon monolith can be within a range from about 0.05 g/cm³ to about 0.7 g/cm³. In some examples, the bulk density range can include a bulk density less than about 0.7 g/cm³. In other examples, the bulk density can be less than 0.6 g/cm³, less than 0.5 g/cm³, or less than 0.1 g/cm³. In some examples the bulk density of the carbon monoliths can be in ranges between about 0.05 g/cm³ and about 0.2 g/cm³. Other ranges can include between about 0.2 g/cm³ and about 0.4 g/cm³, between about 0.4 g/cm³ and about 0.5 g/cm³, between about 0.5 g/cm³ and about 0.6 g/cm³, or between about 0.6 g/cm³ and about 0.7 g/cm³. In some examples, the bulk density can be adjusted by adjusting the temperature rate while forming the carbon fiber monolith, but can also be adjusted by adjusting the airflow or oxygen concentration while forming the carbon fiber monolith.

In some examples, the air permeability of the carbon monoliths can vary based primarily on the bulk density. In some examples, the air permeability can also be affected by the fiber spacing and degree of melting at the nodes while forming the carbon fiber monoliths. In some examples, the air permeability of the carbon monolith can be within a range from about 1×10⁻¹⁰ m² to about 8.5×10⁻¹¹ m². In some examples, the air permeability range can be less than about 9.8×10⁻¹¹ m². In other examples, the air permeability can be less than about 9.5×10⁻¹¹ m², less than about 9.0×10⁻¹¹ m², or less than about 8.8×10⁻¹¹ m². In some examples the air permeability of the carbon monoliths can be in ranges between about 1×10⁻¹⁰ m² and about 9.8×10⁻¹¹ m². Other ranges can include between about 9.8×10⁻¹¹ m² and about 9.5×10⁻¹¹ m², between about 9.5×10⁻¹¹ m² and about 9.3×10⁻¹¹ m², between about 9.3×10⁻¹¹ m² and about 9×10⁻¹¹ m², between about 9×10⁻¹¹ m² and about 8.8×10⁻¹¹ m², or between about 8.8×10⁻¹¹ m² and about 8.5×10⁻¹¹ m². The intrinsic permeability of a porous medium, such as a carbon monolith, measures its ability of letting a fluid pass through it under the influence of a pressure gradient. For practical applications, it is of high interest to predict the permeability of a given medium based on its porous structure.

Furthermore, properties of the activated carbon fibers can also be tailored to decrease the temperature and energy needed to desorb moisture and/or air contaminants from the carbon monolith. As discussed in further detail below, an electric current can be applied to the carbon monolith to induce Joule heating by electrical resistance of the carbon fibers of the carbon monoliths and increase their temperature to aid in the desorption process to remove the moisture and air contaminants from the regenerating carbon monolith. In an example, the electrothermal swing adsorption apparatus 110 can conduct a desorption of an air contaminate (e.g. methyl ethyl ketone) in humid air between about 9.9 kJ/g and about 28 kJ/g.

The first electrothermal swing adsorption apparatus 110 includes a feed 114 that is the intake from the building's HVAC system. The feed 114 may be the same as the intake flow stream 102. The feed 114 may include moisture in the air and other air contaminants.

The feed 114 follows a feed flow path 115 that includes a first feed flow path 115A. The feed flow path 115 is introduced or received into the first chamber 112 via the first feed flow path 115A. The moisture and/or the air contaminants are adsorbed by the active carbon monolith in the first chamber 112 thereby dehumidifying and/or purifying the feed 114. The first chamber 112 is coupled to the output flow stream 104 for the purified feed 114 to exit the first chamber 112 via the first output flow stream 104A. The output flow stream 104, 104A is dehumidified and free of air contaminants that were desorbed by the active carbon monolith in the first chamber 112. In some embodiments, the output flow stream 104, 104A is dehumidified and/or free of the specific air contaminants that the carbon monolith in the first chamber 112 was optimized for and may include additional air contaminants that will be removed by subsequent electrothermal swing adsorption apparatuses (e.g., 120, 130) that are disposed later in series of the intake flow stream 102 of the electrothermal swing adsorption system 100. As discussed above, the output flow stream 104, 104A may then be introduced into the second electrothermal swing adsorption apparatus 120 and then the third electrothermal swing adsorption apparatus 130. As discussed above, after the feed 114 is outputted from all of the electrothermal swing adsorption apparatuses 110, 120, 130 as the output flow stream 104, the electrothermal swing adsorption system 100 can achieve high moisture removal efficiencies of at least 396 mg/g at a relative humidity of 98% and temperature of 298 K. Additionally, after chemical modification treatments, much high adsorption of up to 0.5-0.6 ml of water per gram of fiber has been observed with 100% desorption after heating to 100° C.

The first electrothermal swing adsorption apparatus 110 further includes a purge 116. The purge 116 is a reservoir of a purge gas that is used in the desorption of the moisture and/or air contaminants from the carbon monolith in the second chamber 113. The purge 116 follows a purge flow path 117 that includes a first purge flow path 117A. The purge 116 is introduced or received into the second chamber 113 via the first purge flow path 117A. In some examples, the purge gas can include nitrogen or a noble gas. The purge gas can include varying concentrations of oxygen, however, purge gas oxygen impurity can result in lower regeneration efficiency and shorter adsorbent lifetime. The moisture and/or air contaminants are desorbed from the regenerating carbon monolith in the second chamber 113. The regeneration of the regenerating carbon monolith in the second chamber 113 is performed by applying an electric current to the regenerating carbon monolith to induce Joule heating by electrical resistance of the carbon fibers in the carbon monolith and increase the temperature of the carbon monolith to between 100° and 150° C. to desorb moisture and other adsorbates such as indoor air contaminants. The temperature for desorption may depend on the properties of the carbon monolith in the second chamber 113, the captured moisture or air contaminants being desorbed from the carbon monolith, and any chemical modifications of the carbon monolith. The moisture and air contaminants are desorbed from the carbon monolith and into the purge 116. The moisture and/or concentrated air contaminant purge gas may be outputted out of the second chamber 113 through the removal output flow stream 111 via a first removal output flow stream 111A.

The removal output flow stream 111 may be coupled to a reservoir 118 that collects and stores the moisture and/or air contaminants from the first electrothermal swing adsorption apparatus 110, specifically the first chamber 112. As discussed above, the reservoir 118 may collect and store moisture and/or a specific air contaminant that was adsorbed by the carbon monoliths in the first electrothermal swing adsorption apparatus 110. In some embodiments, the reservoir 118 may include a flow path 119 that is in fluid communication with the feed flow path 115 via a first flow path 119A and is in fluid communication with the purge flow path 117 via a second flow path 119B. In some examples, the design of the reactor system minimizes the temperature that the electrothermal swing adsorption apparatus 110 is exposed to as the walls of the containment vessel are partially cooled by the incoming purge flow path 117 and/or second flow path 119B.

The first electrothermal swing adsorption apparatus 110 operates in a continuous and cyclical manner. In other words, the feed 114 (e.g. intake flow stream 102) is continuously introduced into the first chamber 112 to adsorb the moisture and/or air contaminants from the feed 114 and the purge 116 is continuously introduced into the second chamber 113 to desorb the moisture and/or air contaminants from the carbon monolith in the second chamber 113. When the active carbon monolith in the first chamber 112 begins to reach a predetermined adsorption capacity (e.g., in other words, the carbon monolith cannot adsorb much more moisture and/or air contaminants), the first electrothermal swing adsorption apparatus 110 can be reversed. In other words, the carbon monolith in the first chamber 112 can be regenerated by desorbing moisture and/or air contaminants from the carbon monolith using the purge 116 and the carbon monolith in the second chamber 113 can be activated by adsorbing moisture and/or air contaminants from the feed 114. Accordingly, the first electrothermal swing adsorption apparatus 110 continuously adsorbs and desorbs moisture and/or air contaminants using the carbon monoliths in the first chamber 112 and the second chamber 113.

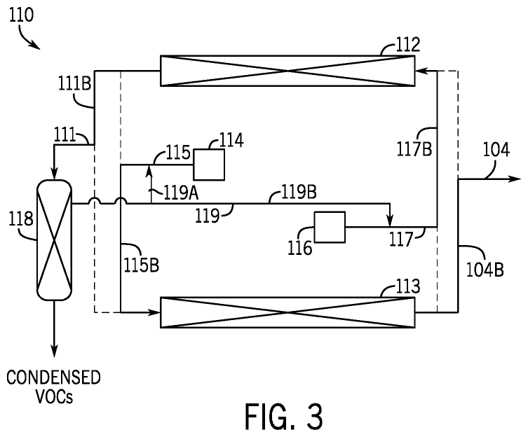

FIG. 3 illustrates a schematic of the first electrothermal swing adsorption apparatus 110 in a second configuration. The second configuration of the first electrothermal swing adsorption apparatus 110 is reversed from the first configuration of the first electrothermal swing adsorption apparatus 110. While FIG. 3 illustrates a schematic of the first electrothermal swing adsorption apparatus 110 in the second configuration, the electrothermal swing adsorption apparatuses 120, 130 in the second configuration are similar to the schematic of the first electrothermal swing adsorption apparatus 110 in the second configuration.

The first electrothermal swing adsorption apparatus 110 in the second configuration includes the first chamber 112 and the second chamber 113. In the illustrated embodiment of the second configuration of the first electrothermal swing adsorption apparatus 110, the first chamber 112 includes a regenerating carbon monolith for desorbing moisture and/or air contaminants and the second chamber 113 includes an active carbon monolith for adsorbing moisture and/or air contaminants. Previously, the regenerating carbon monolith of the first chamber 112 was the active carbon monolith of the first chamber 112 in the first configuration and the active carbon monolith of the second chamber 113 was the regenerating carbon monolith of the second chamber 113 in the first configuration. The first chamber 112 and the second chamber 113 operate in a cyclical fashion in this manner to perform continuous adsorption and desorption of moisture and/or air contaminants.

The first electrothermal swing adsorption apparatus 110 includes the feed 114 that is the intake from the building's HVAC system. The feed 114 may be the same as the intake flow stream 102. The feed 114 may include moisture in the air and other air contaminants.

The feed 114 follows a feed flow path 115 that includes a second feed flow path 115B. The feed flow path 115 is introduced or received into the second chamber 113 via the second feed flow path 115B. The moisture and/or air contaminants are adsorbed by the active carbon monolith in the second chamber 113 thereby dehumidifying and/or purifying the feed 114. The active carbon monolith in the second chamber 113 was the previous regenerating carbon monolith in the second chamber 113 in the first configuration. The second chamber 113 is coupled to the output flow stream 104 for the purified feed 114 to exit the second chamber 113. The output flow stream 104 is dehumidified and free of air contaminants that were desorbed by the active carbon monolith in the second chamber 113. In some embodiments, the output flow stream 104, 104A is dehumidified and/or free of the specific air contaminant that the carbon monolith in the first chamber 112 was optimized for and may include additional air contaminants that will be removed by subsequent electrothermal swing adsorption apparatuses (e.g., 120, 130) that are disposed later in series of the intake flow stream 102 of the electrothermal swing adsorption system 100. As discussed above, the output flow stream 104 may then be introduced or received into the second electrothermal swing adsorption apparatus 120 and then the third electrothermal swing adsorption apparatus 130. As discussed above, after the feed 114 is outputted from all of the electrothermal swing adsorption apparatuses 110, 120, 130, the electrothermal swing adsorption system 100 can achieve high moisture removal efficiencies of at least 396 mg/g at a relative humidity of 98% and temperature of 298 K. Additionally, after chemical modification treatments, much high adsorption of up to 0.5-0.6 ml of water per gram of fiber has been observed with 100% desorption after heating to 100° C.

The first electrothermal swing adsorption apparatus 110 further includes the purge 116. The purge 116 is a reservoir of a purge gas that is used in the desorption of the moisture and/or air contaminants from the carbon monolith in the first chamber 112 in the second configuration. In some examples, the purge gas can include nitrogen or a noble gas. In some examples, the purge gas can include varying concentrations of oxygen and may also consist of inside or outside air. The purge 116 follows the purge flow path 117 that includes a second purge flow path 117B, which is different from the first purge flow path 117A. The purge 116 is introduced or received into the first chamber 112 via the second purge flow path 117B. The moisture and/or air contaminants are desorbed from the regenerating carbon monolith in the first chamber 112, which used to be the active carbon monolith in the first configuration. The regeneration of the regenerating carbon monolith in the first chamber 112 is performed by applying an electric current the regenerating carbon monolith to induce Joule heating by electrical resistance of the carbon fibers in the carbon monolith and increase the temperature of the carbon monolith to between 100° and 150° C. to desorb moisture and other adsorbates such as indoor air contaminants. The temperature for desorption may depend on the properties of the carbon monolith in the first chamber 112, the moisture or air contaminants being desorbed from the carbon monolith, and any chemical modifications of the carbon monolith. The moisture and/or air contaminants are desorbed from the carbon monolith and into the purge 116. The moisture or concentrated air contaminant in the purge 116 may be transferred out of the first chamber 112 through the removal output flow stream 111 via a second removal output flow stream 111B.

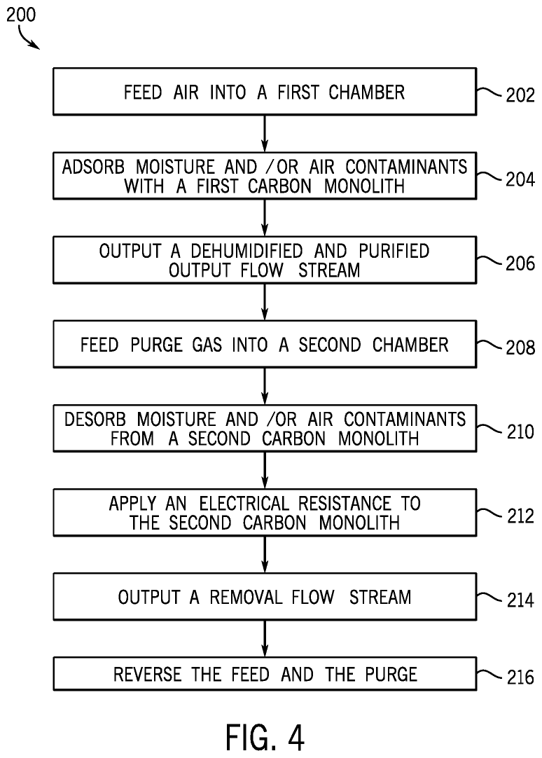

FIG. 4 illustrates a flow chart of a method 200 of dehumidifying and purifying air from a building's HVAC system using the first electrothermal swing adsorption apparatus 110. However, this method is also applicable to the second electrothermal swing adsorption apparatus 120 and the third electrothermal swing adsorption apparatus 130.

Step 202 is directed to feeding air from a building's HVAC system into the first chamber 112 of the first electrothermal swing adsorption apparatus 110. The feed may include moisture in the air as well as air contaminants. Step 204 is directed to adsorbing moisture and/or air contaminants with a first carbon monolith in the first chamber 112. In some embodiments, the first carbon monolith is optimized to adsorb either moisture or a specific air contaminant. In some embodiments, the carbon monolith may be optimized to adsorb moisture and more than one type of air contaminant. Step 206 is directed to discharging a dehumidified and purified output flow stream 104 from the first chamber 112 of the first electrothermal swing adsorption apparatus 110. In some embodiments, the dehumidified and purified output flow stream 104 is free of moisture and/or the specific air contaminant that was adsorbed by the first carbon monolith in the first chamber 112 but might contain additional moisture and/or air contaminants that will be removed by the electrothermal swing adsorption apparatuses 120, 130.

Step 208 is directed to feeding a purge gas into the second chamber 113 of the first electrothermal swing adsorption apparatus 110 that is separate from the first chamber 112. Step 210 is directed to desorbing moisture and/or air contaminants from a second carbon monolith with the purge gas in the second chamber 113. The adsorption of the moisture and/or air contaminants in the first chamber 112 occurs simultaneously as the desorption of the moisture and/or air contaminants in the second chamber 113. In some embodiments, the second carbon monolith had previously adsorbed moisture and/or air contaminants. In some situations, the second carbon monolith may not have adsorbed any moisture and/or air contaminants, such as when the carbon monolith is first added to the second chamber 113 and is being used for the first time. Step 212 is directed to applying an electrical current to the second carbon monolith in the second chamber 113 to raise the temperature of the regenerating carbon monolith to desorb moisture and/or air contaminants from the regenerating carbon monolith. The temperature can be raised to between 100° and 150° C. The temperature is raised to aid in the desorption process. Accordingly, raising the temperature occurs at the same time as the desorption step 210. Step 214 is directed to discharging a removal output flow stream 111 from the second chamber 113 of the first electrothermal swing adsorption apparatus 110 of moisture and/or air contaminants.

Step 216 is directed to reversing the feed of the air from the building's HVAC system from the first chamber 112 to the second chamber 113 and reversing the feed of the purge gas from the second chamber 113 to the first chamber 112 when the first carbon monolith has adsorbed a predetermined amount of moisture and/or air contaminants. In other words, the carbon monolith has reached a predetermined adsorption capacity. In some embodiments, the first chamber 112 and the second chamber 113 may each include a sensor to monitor the outlet flow to determine the amount of moisture and/or air contaminants the carbon monolith has adsorbed so that the first electrothermal swing adsorption apparatus 110 may be reversed so that the moisture and/or air contaminants are be removed from the carbon monolith. Accordingly, the second carbon monolith in the second chamber 113 can adsorb the moisture and/or air contaminants and the carbon monolith in the first chamber 112 can be desorbed of the moisture and/or air contaminants captured in the carbon monolith.

Carbon fibers are good conductors of electricity and heat, the amount of energy needed through the electrothermal process to raise their temperature is relatively low.

The lower cost of coal-based active carbon fibers and the lower operating cost of electrothermal swing adsorption/desorption enables coal-based electrothermal swing adsorption to be cost competitive with other desiccant type systems, such as liquid desiccant air conditioning and solid desiccant systems. The lower cost of coal-based active carbon fiber in active carbon monoliths and the lower operating cost of electrothermal swing adsorption will enable electrothermal swing adsorption system with active carbon fibers dehumidification systems to be cost competitive with other types of dehumidification systems.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. An electrothermal swing adsorption system comprising:
an electrothermal swing adsorption apparatus comprising:
a first chamber comprising at least one carbon monolith; and
a second chamber comprising at least one carbon monolith;
wherein the electrothermal swing adsorption apparatus is configured to receive a feed of air;
wherein the electrothermal swing adsorption system desorbs at least one of moisture and air contaminants from the feed of air;
wherein the electrothermal swing adsorption apparatus discharges a dehumidified flow stream; and
wherein the electrothermal swing adsorption apparatus discharges a removal output flow stream of at least one of moisture and air contaminants.

2. The electrothermal swing adsorption apparatus of claim 1, wherein the at least one carbon monolith of the first chamber adsorbs at least one of moisture and air contaminants and the at least one carbon monolith of the second chamber desorbs at least one of moisture and air contaminants simultaneously as the at least one carbon monolith of the first chamber adsorbs at least one of moisture and air contaminants.

3. The electrothermal swing adsorption apparatus of claim 1, wherein the at least one carbon monolith of the second chamber adsorbs at least one of moisture and air contaminants and the at least one carbon monolith of the first chamber desorbs at least one of moisture and air contaminants simultaneously as the at least one carbon monolith of the first chamber adsorbs at least one of moisture and air contaminants.

4. The electrothermal swing adsorption apparatus of claim 1, wherein the first chamber and the second chamber operate in a cyclical fashion to perform continuous adsorption and desorption of at least one of moisture and air contaminants such that adsorption occurs in one of the first chamber and the second chamber while desorption occurs in the other of the first chamber and the second chamber.

5. The electrothermal swing adsorption system of claim 1, wherein each carbon monolith comprises coal-based activated carbon fibers.

6. The electrothermal swing adsorption system of claim 1, wherein each carbon monolith is optimized to adsorb moisture or a specific air contaminant.

7. The electrothermal swing adsorption system of claim 2, wherein the electrothermal swing adsorption apparatus comprises a reservoir to store the moisture desorbed from the at least one carbon monolith of the second chamber.

8. The electrothermal swing adsorption system of claim 1, further comprising a plurality of electrothermal swing adsorption apparatuses that are arranged in series such that each electrothermal swing adsorption apparatus adsorbs at least one or more of moisture and air contaminants from the feed of the air.

9. The electrothermal swing adsorption system of claim 8, wherein each electrothermal swing adsorption apparatus discharges the removal output flow stream for at least one of moisture and air contaminants.

10. The electrothermal swing adsorption system of claim 9, wherein each electrothermal swing adsorption apparatus comprises a reservoir to store the outputs at least one of moisture and air contaminants.

11. The electrothermal swing adsorption system of claim 1, wherein the electrothermal swing adsorption system achieves moisture removal efficiencies of at least 396 mg/g at a relative humidity of 98% and temperature of 298 K.

12. A method of dehumidifying and purifying air from a building HVAC system utilizing an electrothermal swing adsorption system comprising:
feeding air from a building HVAC system into a first chamber of an electrothermal swing adsorption apparatus;
adsorbing the at least one of moisture and air contaminants with a first carbon monolith in the first chamber; and
discharging an output flow stream from the first chamber of the electrothermal swing adsorption apparatus of dehumidified and purified air.

13. The method of claim 12, further comprising:
feeding a purge gas into a second chamber of the electrothermal swing adsorption apparatus that is separate from the first chamber; and
desorbing at least one of moisture and air contaminants from a second carbon monolith with the purge gas in the second chamber, wherein the second carbon monolith previously adsorbed at least one of moisture and air contaminants.

14. The method of claim 13, further comprising discharging a removal stream from the second chamber of the electrothermal swing adsorption apparatus of at least one of moisture and air contaminants.

15. The method of claim 13, further comprising applying an electrical current to the second carbon monolith in the second chamber to raise a temperature of the second carbon monolith to desorb the at least one of moisture and air contaminants from the second carbon monolith.

16. The method of claim 13, further comprising reversing the feed of air from the building HVAC from the first chamber to the second chamber and reversing the feed of the purge gas from the second chamber to the first chamber when the first carbon monolith has adsorbed a predetermined amount of the at least one of moisture and air contaminants.

17. The method of claim 16, further comprising:
adsorbing the at least one of moisture and air contaminants with the second carbon monolith in the second chamber; and
desorbing at least one of moisture and air contaminants from the first carbon monolith with the purge gas in the first chamber.

18. The method of claim 13, wherein the first carbon monolith and the second carbon monolith comprise coal-based activated carbon fibers.

19. The method of claim 18, wherein the coal-based activated carbon fibers are optimized to adsorb moisture or a specific air contaminant.

20. The method of claim 13, wherein the electrothermal swing adsorption system comprises a plurality of electrothermal swing adsorption apparatuses that are arranged in series, wherein the feed of air of the building HVAC or industrial process air is fed into each electrothermal swing adsorption apparatus in series and each electrothermal swing adsorption apparatus adsorbs moisture or a specific air contaminant.
